(19) United States
(12) Patent Application Publication
(10) Pub. No.: US 2005/0255025 A1
(43) Pub. Date: Nov. 17, 2005

(54) Phosphine fast-generating device and the method used by the device

(76) Inventor: Hung-Yi Chen, Taichung (TW)

Correspondence Address: Hung-Yi Chen, 235 Chung-Ho, Box 8-24, Taipei, TW

(21) Appl. No.: 10/846,890

(22) Filed: May 17, 2004

(51) Int. Cl. C01B 25/06

(52) U.S. Cl. 423/299; 422/188; 422/198

(57) ABSTRACT

A phosphine fast-generating device comprises a tank; a reaction chamber formed in the tank; an agent input opening installed at an upper side of the reaction chamber; a nitrogen injection system, a high pressure spraying system and a phosphine purifying system connected to the upper side of the reaction chamber; a pressure reduction chamber connected to the phosphine purifying system; the pressure reduction chamber being retained in a negative pressure so that when the phosphine passes through the phosphine purifying system, the phosphine will be purified and thus the phosphine is sucked in the pressure reduction chamber. Moreover, a phosphine fast-generating method for generating phosphine in the phosphine fast-generating device is also disclosed.

### FIELD OF THE INVENTION

The present invention relates to the generation of phosphine, and particular to a phosphine fast-generating device and a phosphine fast-generating method.

### BACKGROUND OF THE INVENTION

The toxicity of methyl bromide (CH₃Br) has the effect to kill pests and thus it is widely used in various fields, such as storage of books, plants and agriculture, etc., but unluckily, methyl bromide is harmful to human body only at a very short time period of contact. Furthermore, methyl bromide will decompose the ozone in the ozone layer of earth so that the ozone layer generates holes or becomes thin. Thereby, it has been requested to reduce the use of methyl bromide.

To improve above mentioned defects, phosphine has been developed to replace the use of methyl bromide. In use of phosphine, the aluminum phosphide (AlP) is used to react with air so as to release gasified phosphine, while solid aluminum hydroxide (Al(OH)₃) is remained. In another application, magnesium phosphide is used. The characteristics of the magnesium phosphide are similar to that of the aluminum phosphide. When the magnesium reacts with water, it will release gasified phosphide and solid magnesium hodroxide (Ma(OH)₂) is left. Phosphine is harmless to human body, remains on the objects; induces cancers and destroys ozone layer of the atmosphere. Thereby, phosphine is a better one for replacing methyl bromide. However, the above mentioned prior art ways for generating phosphine has the following defects.

Firstly, a long time period is necessary to kill pests, which is not suitable to the maintenance of objects with short lifetimes, such as followers. Thereby, if phosphine is used in the pressure reduction chamber, since a long time period is necessary so that the usage of the pressure reduction chamber is reduced and the cost is increased.

Secondly, the aluminum phosphide and magnesium phosphide is placed on piece by one piece. They cannot be overlapped. Thereby, a large volume is necessary so that labor and cost are high.

Thirdly, the placement of aluminum phosphide and magnesium phosphide induces the possibility of to harm human body. Moreover, it is possible that the workers breath the phosphine into body so as to hurt the body.

In the process of generating phosphine, aluminum hydroxide magnesium hydroxide will generate so as to pollute the work field. Thus the worker must take time to clean the places. This also induce the increment of cost.

### SUMMARY OF THE INVENTION

Accordingly, the primary object of the present invention is to provide a phosphine fast-generating device. The device comprises a tank; a reaction chamber formed in the tank; a agent input opening installed at an upper side of the reaction chamber; a nitrogen injection system, a high pressure spraying system and a phosphine purifying system connected to the upper side of the reaction chamber; a pressure reduction chamber structure to the phosphine purifying system; the pressure reduction chamber being retained in a negative pressure so that when the phosphine passes through the phosphine purifying system, the phosphine will be purified and thus the phosphine is sucked in the pressure reduction chamber. Moreover, a phosphine fast-generating method for generating phosphine in the phosphine fast-generating device is also disclosed.

Moreover, the present invention provides a phosphine fast-generating method. The method comprises the steps of: inputting reactant into the reaction chamber; opening an air pumping valve so that air the reaction chamber will continuously flow to the pressure reduction chamber in negative pressure through a phosphine purifying system so as to drain oxygen in the reaction chamber to prevent the phosphine from burning by itself and the reaction chamber is retained in negative pressure; injecting nitrogen, wherein an air inlet valve is opened; nitrogen is injected continuously into the reaction chamber so as to avoid the danger of high density of phosphine; so that the air in the reaction chamber 10 flows to be sucked into the pressure reduction chamber; spraying water by a high pressure spraying system; removing undesired objects; wherein a dreg removing system below the reaction chamber is actuated, the dreg in the reaction chamber is flushed by the high pressure spraying system so that the dregs fall into the dreg removing system for being drained out.

The various objects and advantages of the present invention will be more readily understood from the following detailed description when read in conjunction with the appended drawing.

### BRIEF DESCRIPTION OF THE DRAWINGS

FIG. 1 is a schematic view about the phosphine fast-generating device of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

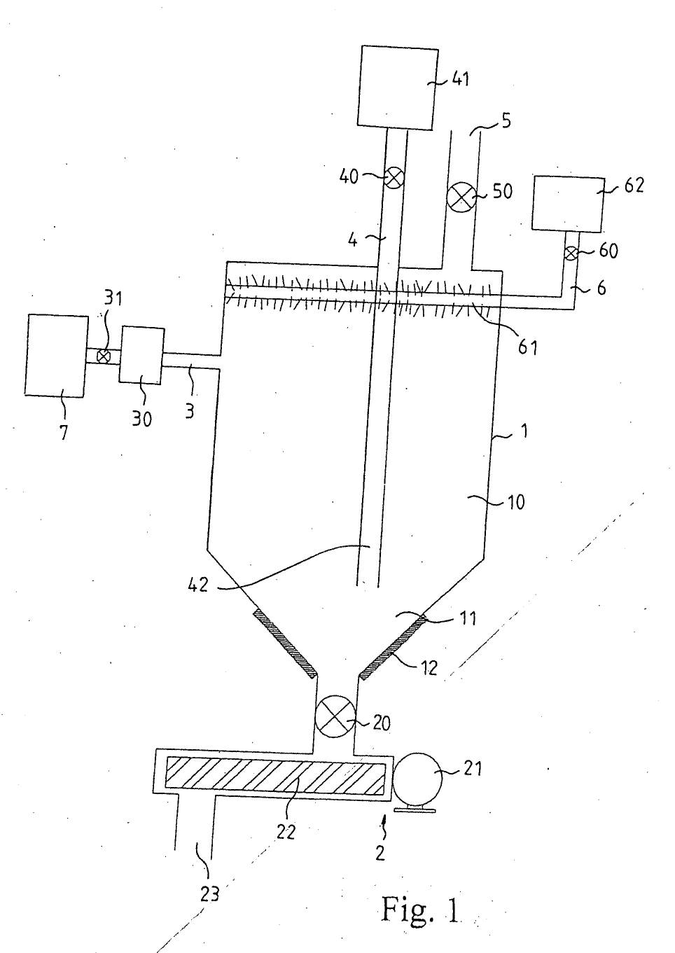

With reference to FIG. 1, the phosphine fast-generating device is illustrated. The device includes a tank 1 which is explosive-proof and pressure-tolerant.

A reaction chamber 10 is formed in the tank 1. The volume of the reaction chamber 1 is about 200 liters (however, this is not confined, other value is usable as desired). An upper side of the reaction chamber 10 is installed with an air outlet 3, an air inlet 4, an agent input opening 5 and a water inlet 6.

A tapered space 11 is communicated to and below the reaction chamber 1. A heating unit 12 is installed at the lateral side of the tapered space 11. An exhausting valve 20 has one end connected to a lower end of the tapered space 11 and another end of the exhausting valve 20 is connected to a dreg removing system 2. A motor 21 is connected to the dreg removing system 2 for driving a push rod 22 so as to remove residue generated from the reaction from a dreg outlet 23.

The air outlet 3 is connected to a phosphine purifying system 30. The phosphine purifying system 30 is further connected to an air pumping valve 31 which is then connected to a pressure reduction chamber 7. The air pressure of the pressure reduction chamber 7 is retained in a negative pressure. When the air pumping valve 31 is actuated, air in the reaction chamber 10, phosphine purifying system 30, and pressure reduction chamber 7 will flow unidirectionally. Thus, air will flow to the pressure reduction chamber 7 having a negative pressure. When air flows through the phosphine purifying system 30, the air will be purified. Air other than phosphine will exhaust out. The phosphine will flow into the pressure reduction chamber 7 so as to kill insect therein.

An air inlet valve 40 is installed above one end of the air inlet 4 and another end of the air inlet 4 is connected to a nitrogen injection system 41. The air inlet valve 40 and the nitrogen injection system 41 serve to control the nitrogen inputting into the nitrogen injection system 41. The inputted nitrogen can be guided to the reaction chamber 10 of the tank 1. A tube 42 is extended into the reaction chamber 10 from the air inlet 4. An opening of the distal end of the tube 42 is at the tapered space 11 near the heating unit 12 so that the nitrogen from the nitrogen injection system 41 can be guided to the lower portion of the tapered space 11. Thereby, by the injection nitrogen, the generated phosphine will flow rapidly to the phosphine purifying system 30 and then is purified. Then the air is sucked to the pressure reduction chamber 7.

The agent input opening 5 is installed with an agent input valve 50. When the agent input valve 50 is opened, the aliminium phosphide or magnesium phosphide, etc. can be inputted to the reaction chamber 10 of the tank 1. When the agent input valve 50 is closed, the air in the reaction chamber 10 is released out.

A water valve 60 is installed in the water inlet 6. A spraying tube 61 is formed in the reaction chamber 10 of the tank 1 extending from one end of the water inlet 6. Another end of the water inlet 6 is connected to a high pressure spraying system 62.

Above said is the phosphine fast-generating device of the present invention, where the phosphine purifying system 30, nitrogen injection system 41, high pressure spraying system 62 and pressure reduction chamber 7 are known in the prior art and thus the detail will not described here.

In the present invention, the phosphine fast-generating device according to the present invention will be described herein. In the following the method for fast generating phosphine will be described herein.

It should be noted that before reduction of pressure, the pressure reduction chamber 7 is in negative pressure and the reaction chamber 10 is tightly sealed. The method comprising the following steps.

The first step is to input agents, where the agent input valve 50 of the agent input opening 5 is opened and reactants (aliminium phosphide and magnesium phosphide) is inputted to a reaction chamber 10. Then the agent input valve 50 is closed.

The second step is an air pumping step, where the air pumping valve 31 is opened automatically. In reacting period, the air pumping valve 31 is retained in the opening state. Air in the reaction chamber 10 will continuously flow to the pressure reduction chamber 7 in negative pressure through a phosphine purifying system 30 so as to drain oxygen in the reaction chamber 10 to prevent the phosphine from burning by itself. The reaction chamber 10 can be retained in negative pressure so as to prevent the phosphine to flow out.

The third step is to injection nitrogen, where the air inlet valve 40 is opened. Nitrogen is injected continuously into the tapered space 11 at the lower side of the reaction chamber 10 through the nitrogen injection system 41, air inlet 4, and tube 42 before the mass generation of the phosphine so as to avoid the danger of high density of phosphine. Thereby, the nitrogen introduced into the tapered space 11 at the lower side of the reaction chamber 10 is helpful to the airflow so that the air in the reaction chamber 10 flows upwards to be sucked into the pressure reduction chamber 7.

The fourth step is to spray water, where a water valve is opened in a short time period so that the spraying tube 62 of the high pressure spraying system 62 will spray water. After 5 minutes, the water valve 60 is opened shortly. The process is repeated three to five times as desired for avoiding the reaction to be performed too quickly so that the density of the phosphine is too high.

The fifth step is to remove undesired objects. After the phosphine is introduced into the pressure reduction chamber 7, the air pumping valve 31 is closed and the water valve 60 is opened. The water spraying tube 61 of the high pressure spraying system 62 will spray water to flush the dregs in the reaction chamber 10 into the dreg removing system 2. The push rod 22 serves to push the dregs into the dreg outlet 23 for removing the dregs. When all the dregs are removed, water is stopped and the heating unit 12 is actuated and the agent input valve 50 is opened. By the heat from the heating unit 12, water in the reaction chamber 10 is evaporated from the agent input opening 5 so that the reaction chamber 10 is retained in a dry state. Then the agent input opening 5 and the heating unit 5 are closed for reuse.

The method of the present invention causes that the reaction in the reaction chamber 10 is complete. A heating process can be added between the fourth and fifth steps. The object and way will be described hereinafter.

In the heating of the present invention, when the reaction is performed through about 30 minutes. The reactants and generating objects are gradually approached to an equilibrium state so that the generation of the phosphine becomes slow. Then the heating unit 12 is actuated to speed the generation of the phosphine to avoid the incomplete reaction of the reactant. After heating through about 30 minutes, since gas in the reaction chamber 10 is sucked into the phosphine purifying system 30 and the phosphine is purified and then is introduced into the pressure reduction chamber 7. The reactant is gradually reacted. Thereby, the air inlet valve 40 can be stopped and closed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A phosphine fast-generating device comprising:
a tank;
a reaction chamber formed in the tank;
an agent input opening installed at an upper side of the reaction chamber;
a nitrogen injection system, a high pressure spraying system and a phosphine purifying system connected to the upper side of the reaction chamber;
a pressure reduction chamber connected to the phosphine purifying system; the pressure reduction chamber being retained in a negative pressure so that when the phosphine passes through the phosphine purifying system, the phosphine will be purified and thus the phosphine is sucked in the pressure reduction chamber.

2. The phosphine fast-generating device as claimed in claim 1, wherein a heating unit is installed below the reaction chamber to increase the reaction speed.

3. The phosphine fast-generating device as claimed in claim 1, wherein a tapered space communicated to and below the reaction chamber.

4. The phosphine fast-generating device as claimed in claim 1, wherein nitrogen is guided to a lower side of the reaction chamber through a tube for driving air in the reaction chamber to be guided to the pressure reduction chamber.

5. A phosphine fast-generating method comprising the steps of:
inputting reactant into the reaction chamber;
opening an air pumping valve so that air in the reaction chamber continuously flows to the pressure reduction chamber which is set in negative pressure state through a phosphine purifying system so as to drain oxygen in the reaction chamber to prevent the phosphine from burning by itself and the reaction chamber is retained in negative pressure;
injecting nitrogen, wherein an air inlet valve is opened; nitrogen is injected continuously into the reaction chamber so as to avoid the danger of high density of phosphine; so that the air in the reaction chamber flows to be sucked into the pressure reduction chamber;
spraying water by a high pressure spraying system;
removing undesired objects; wherein a dreg removing system below the reaction chamber is actuated, the dreg in the reaction chamber is flushed by the high pressure spraying system so that the dregs fall into the dreg removing system for being drained out.

6. The phosphine fast-generating method of as claimed in claim 5, wherein the reactant is aliminium phosphide.

7. The phosphine fast-generating method of as claimed in claim 5, wherein the reactant is magnesium phosphide.

8. The phosphine fast-generating method of as claimed in claim 5, wherein a heating step is added between the spraying step and the removing step, wherein a heating unit is heated for increasing the generating amount of phosphine; when all the reactants are used up, the air inlet valve is closed and the heat unit is stopped.

9. The phosphine fast-generating method of as claimed in claim 5, wherein when the flushing step is finished, the heating unit is actuated and an agent input opening is opened for evaporating water in reaction chamber; then the agent input opening and heating unit are closed so as to be used next time.
